(19) United States
(12) Patent Application Publication
(10) Pub. No.: US 2016/0009914 A1
(43) Pub. Date: Jan. 14, 2016

(54) METHOD FOR PRODUCING AN AQUEOUS DISPERSION OF POLY(HYDROXYALKANOATES)

(71) Applicants: Gwenaelle SOBOTKA, London (GB); Nikolay NENOV, Harlow (GB)

(72) Inventors: Gwenaelle SOBOTKA, London (GB); Nikolay NENOV, Harlow (GB)

(73) Assignee: Synthomer (UK) Limited, Harlow, Essex (GB)

(21) Appl. No.: 14/420,648

(22) PCT Filed: Aug. 10, 2012
(86) PCT No.: PCT/EP2012/003423

§ 371 Date: Oct. 1, 2015

(51) Int. Cl. C08L 67/04; C08L 29/04

(52) U.S. Cl. CPC C08L 67/04; C08L 29/04; C08L 2201/06; C08L 2205/03

(57) ABSTRACT

A method for producing an aqueous dispersion of poly(hydroxyalkanoates) is provided. The method comprises dispersing a powder containing one or more poly(hydroxylalkanoates) in an aqueous medium in presence of a colloidal stabilizer using a high shear disperser at a shear rate of 10 s-1-750,000 s-1 and to aqueous dispersions obtainable thereby.

The present invention relates to the preparation of stable aqueous dispersions of poly(hydroxyalkanoates) as well as to aqueous dispersions obtainable by said method.

### BACKGROUND OF THE INVENTION

Poly(hydroxyalkanoates) (PHA) are accumulated by many microorganisms, in particular bacteria, for example of the genera Alcanigenes, Athiorhodium, Azotobacter, Bacillus, Nocardia, Pseudomonas, Rhizobium and Spirillium, as an energy reserve material. It is conveniently prepared by cultivating the microorganisms in an aqueous medium on an energy and carbon source. At least part of the cultivation is preferably conducted under limitation of a nutrient essential for growth but not required for PHA accumulation. Examples of suitable processes are described in EP-A 156 69 and EP-A 46 344. These biopolymers are biodegradable and their properties range from rigid to elastic. They combine the barrier film properties of polyesters with the good mechanical properties of polyethylene and polypropylene. Many PHA materials have been produced and are commercially available in powdered form which is a convenient way of handling these products in thermoplastic applications. For specific applications however such as coatings, adhesives or formation of carriers for drug deliveries as well as for various post-functionalization processes it would be beneficial to have stable aqueous dispersions of poly(hydroxyalkanoates) since this would facilitate its processing and broaden the methods of use.

One approach used in the prior art to obtain aqueous dispersions of poly(hydroxyalkanoates) is starting directly from the medium obtained from the microbiological process for making poly(hydroxyalkanoates). Such media still contain non-PHA cell material which has to be destroyed and residues thereof removed in order to obtain the desired aqueous dispersion of poly(hydroxyalkanoates). Prior art documents representative for this approach of obtaining aqueous colloidal dispersions of poly(hydroxyalkanoates) directly from the biomass are WO 91/13207, U.S. Pat. No. 5,977,250, WO 97/21762, WO 96/00263, U.S. Pat. No. 6,024,784 and GB 2 291 648.

One principle disadvantage of this technology is that the aqueous dispersion has to be prepared starting from the microbiological process which is particularly for endusers not attractive since they normally do not have the required experience and technology for the microbiological processes.

Thus it would be beneficial to have a process for making stable aqueous dispersions of poly(hydroxyalkanoates) starting from a powder comprising one or more poly(hydroxyalkanoates). A variety of such powders are commercially available.

A different approach was used in US 2007/0088099. According to the teaching of this reference first a blend of a biodegradable polymers which can be poly(hydroxyalkanoates) and a viscosity-reducing agent is prepared by melt blending both components to prepare a molten organic phase. Subsequently the molten organic phase is mixed with an aqueous phase comprising a stabilizer to form an aqueous dispersion of the biodegradable polymer.

According to a third approach as disclosed in DE-A 40 40 158 granular polyhydroxybutyrate is first slurried in water, then ground and filtered. The wet filter cake having a water content of 40% is then directly with a drying dispersed in water using a surfactant a polyoxyethyleneglycerol monolaureate which is a traditional surfactant.

Following a fourth approach as disclosed in CN-A 101538400 for making aqueous dispersions of poly(hydroxyalkanoates) the poly(hydroxyalkanoate) is first dissolved in an organic solvent and the thus obtained organic solution of the poly(hydroxyalkanoate) is dispersed in water containing an emulsifier as well as optionally a dispersant using high-speed mixing. Suitable dispersants are poly(vinylalcohol), methylcellulose or other cellulose based modified polymers.

The latter three approaches have the disadvantage that an additional process step is necessary either melting the poly(hydroxyalkanoate) or grinding an aqueous slurry of the poly(hydroxyalkanoate) or dissolving the poly(hydroxyalkanoate) in a solvent. The last approach has the additional disadvantage that the organic solvent has to be removed and then either disposed or recycled which results in additional process steps and energy consumption.

Furthermore conventional surfactants have been proven to be unsuitable to provide stable dispersions of PHA in water.

In light of the above discussed prior art the object of the present invention is to provide a process wherein a powder of poly(hydroxyalkanoate), for example those commercially available, can directly be dispersed in an aqueous media to provide stable dispersions for subsequent use.

### SUMMARY OF THE INVENTION

This object has been attained by a method for producing an aqueous dispersion of poly(hydroxyalkanoates) comprising dispersing a powder containing one or more poly(hydroxyalkanoates) in an aqueous medium in presence of a colloidal stabilizer using a high shear disperser at a share rate of 10 s⁻¹-750,000 s⁻¹.

The inventors have surprisingly found out that powders containing one or more poly(hydroxyalkanoates) can be directly dispersed in an aqueous system without using intermediate steps like melting the polymer, dissolving the polymer or grinding an aqueous slurry if a colloidal stabilizer is present and the dispersing step is conducted at a share of 4 s⁻¹-750,000 s⁻¹.

This method offers a possibility to endusers of poly(hydroxyalkanoates) to prepare stable aqueous dispersions of poly(hydroxyalkanoates) from commercially available powders in a environmentally friendly, easy to perform and effective way.

According to a preferred embodiment of the present invention the colloidal stabilizer is selected from poly(vinylalcohol) starch and starch derivatives as well as cellulose and cellulose derivatives. These stearic type dispersions stabilizers are biodegradable, easy to handle, readily available and provide the required long term stability with a reduced adverse environmental impact compared to conventional surfactants.

Thus according to a preferred embodiment of the present invention the aqueous dispersion is free of conventional anionic or cationic or nonionic surfactants. It is particularly preferred if none of the types of surfactants are present.

Thus according to this preferred embodiment of the present invention no additional surfactants are used and a stable aqueous dispersion of poly(hydroxyalkanoates) is obtained containing solely biodegradable components and is therefore particularly environmentally friendly.

### DETAILED DESCRIPTION OF THE PRESENT INVENTION

The present invention relates to a process wherein powders comprising one or more poly(hydroxyalkanoates) can be directly dispersed in an aqueous medium without any additional process steps thereby forming stable aqueous dispersions of poly(hydroxyalkanoates).

Suitable poly(hydroxyalkanoates) according to the present invention comprise structural units that are derived from short chain length and medium chain length hydroxyalkanoates. Preferably the chain length of the alkanoates is from C₃ to C₁₆. Particularly suitable poly(hydroxyalkanoates) that are also commercially available comprise structural units derived from 3-hydroxybutyrate, 4-hydroxy-butyrate, 3-hydroxyvalerate, 3-hydroxyhexanoate, 3-hydroxynonanoate, 3-hydroxypropionate and mixtures thereof.

Suitable poly(hydroxyalkanoates) according to the present invention are poly(3-hydroxybutyrate), poly(4-hydroxybutyrate), poly(3-hydroxybutyrate-co-4-hydroxy-butyrate), poly(3-hydroxybutyrate-co-3-hydroxyvalerate), poly(3-hydroxybutyrate-co-3-hydroxyhaxanoate), poly-3-hydroxyoctanoate and mixtures thereof.

Such poly(hydroxyalkanoates) are for example commercially available from Tianjin Green Material (poly-3-hydroxybutyrate-co-4-hydroxybutyrate), Tianan Biologic (poly-3-hydroxybutyrate-co-4-hydroxybutyrate), Ecomann Biotechnologies (poly-3-hydroxybutyrate-co-3-hydroxyvalerate), Biomatera Inc. (poly-3-hydroxybutyrate-co-3-hydroxyvalerate), Polyferm Canada (poly-3-hydroxynonaoate, poly-3-hydroxyhexanoate, poly-3-hydroxyoctanoate).

When dispersing the poly(hydroxyalkanoates) according to the process of the present invention in an aqueous medium the used liquid carrier is preferably substantially free of any organic solvents. By “substantially free of any organic solvent” it is meant that no more than 20 wt.-% of the liquid carrier of organic solvent are present. Thus it is preferred that the liquid carrier forming the aqueous phase according to the present invention comprises at least 80 wt.-%, preferably at least 90 wt.-%, more preferred at least 95 wt.-%, most preferred at least 99 wt.-% water based on the total weight of the liquid carrier. It is particularly preferred if the aqueous medium is free of any organic solvents.

According to the process of the present invention any high shear disperser known to a person skilled in the art can be applied as long as the required shear rate can be adjusted.

The shear rate according the present invention can be calculated from the rheology formula as follows:

$$γ = \frac{2 Ω {R}_{1}^{2} {R}_{2}^{2}}{{R}^{2} {X}_{0} ( {R}_{1} + {R}_{2} )}$$

wherein γ is the shear rate in s⁻¹, Ω is the angular blade velocity (Ω=rpm·2Pi/60), R₁ is the radius of the blade of the used disperser, R₂ is the radius of the container, X₀ is the width of the gap between the blade and side of the container and R is the distance between the blade and the bottom of the container.

The shear rate according to the present invention is 10 s⁻¹-750,000 s⁻¹, preferably 1000 s⁻¹-250,000 s⁻¹, more preferred 4,000 s⁻¹-100,000 s⁻¹, even more preferred 5,000 s⁻¹-50,000 s⁻¹ and most preferred 5,000 s⁻¹-20,000 s⁻¹.

When employing the process of the present invention a broad range of concentrations of poly(hydroxyalkanoates) in the aqueous medium can be adjusted.

The poly(hydroxyalkanoate) can be present in the aqueous dispersion in an amount of 5-90 wt.-%, preferably 15-70 wt.-%, more preferred 25-60 wt.-%, most preferred 30-50 wt.-% based on the total weight of the aqueous dispersion.

The colloidal stabilizer can be present in the aqueous dispersion of the present invention in an amount of 0.5-7 wt.-%, preferably 2-6 wt.-%, more preferred 3.5-5 wt.-% based on the total weight of the aqueous dispersion.

A suitable colloidal stabilizer may be selected from poly(vinylalcohol), starch and starch derivatives for example selected from dextrin, acetylated starch, hydroxypropyl starch, hydroxyethyl starch carboxymethyl starch, cellulose and cellulose derivatives for example selected from methyl cellulose, ethyl cellulose, methyl-ethyl cellulose, carboxymethyl cellulose, hydroxyethyl cellulose, hydroxypropyl cellulose, hydroxypropylmethyl cellulose, hydroxyethylethyl cellulose, hydroxyethylmethyl cellulose and mixtures thereof. Preferred stabilizers are selected from poly(vinylalcohols). A wide range of poly(vinylalcohols) are commercially available. One class of suitable poly(vinylalcohols) are manufactured from polvinylacetate by alkoholysis thereby providing poly(vinylalcohols) with a wide degree of hydrolysis (saponification).

The degree of hydrolysis (saponification) can be in the range of 60-100%, preferably 80-100% and more preferred 85-98%.

Such products are commercially available under the trade mark Mowiol® manufactured by Kuraray.

Particularly preferred polyvinyl stabilizers according to the present invention show at 4 wt.-% concentration dissolved in water a viscosity measured at 20° C. according to DIN 53015 using the Ball No. 2 of 15-140 mPas, preferably 15-100 mPas, more preferred 20-80 mPas, most preferred 30-70 mPas. It has been surprisingly found that poly(vinylalcohols) within the above specified viscosity range give particularly stable aqueous dispersions of poly(hydroxyalkanoates).

The method according to the present invention results in an aqueous dispersion of the hydroxyalkanoates wherein the number average particle size of the poly(hydroxyalkanoates) can be varied in a wide range. The number average particle size measured using a Dark-field microscope as will be explained in more detail in the experimental part of the present application can be in the range of 30-5,000 nm, preferably 150-2,000 nm, more preferred 250-1,000 nm, most preferred 500-1,000 nm.

Furthermore according to the process of the present invention conventional compounding additives might be added during the process for producing the aqueous dispersion of poly(hydroxyalkanoates). Suitable compounding additives are selected from antifoam agents for example mineral oil or silicone oil based defoaming agents such as Defoamer 1215M, TEGO Antifoam 2-89 or Foamstopper 101, available from Synthomer Ltd. biocides such as Acticide MBS, Acticide 45, CMIT:MIT, JMAC or Omacide, and mixtures thereof.

One of the advantages of the present invention is that aqueous dispersions of poly(hydroxyalkanoates) can be prepared in an easy and economic way directly from the poly(hydroxyalkanoate) in powder form which for example might be commercially available. The thus obtained aqueous dispersions can then depending on the end use further modified. For example according to one embodiment it is possible to blend the poly(hydroxyalkanoate) dispersions obtained according to the method of the present invention with a variety of aqueous based homo- or copolymers that might present in latex or dispersion form.

Thus the method according to the present invention may further comprise mixing of the aqueous dispersion of poly(hydroxyalkanoates) with at least one further aqueous polymer composition comprising a polymer different from poly(hydroxy-alkanoates). The amount of the at least one further aqueous polymer composition comprising a polymer different from poly(hydroxyalkanoates) can range from 5-90 wt.-%, preferably 15-70 wt.-%, more preferred 25-50 wt.-% based on the total amount of the aqueous dispersion of poly(hydroxyalkanoates) and the at least one further aqueous polymer composition comprising a polymer different from poly(hydroxyalkanoates).

As polymer different from poly(hydroxyalkanoates) a wide range of homo and copolymers may be selected. Suitable polymers can be styrene homo and copolymers, butadiene homo and copolymers, acrylic or methacrylic homo and copolymers, vinylacetate homo or copolymers, acrylonitrile homo and copolymers, poly(vinylacetate-co-ethylene), polyurethanes, polyesters and mixtures thereof.

As a consequence the present invention allows to fine-tune the properties of the final aqueous dispersion not only by adjusting the amount and type of poly(hydroxyalkanoate) in the aqueous dispersion but also by mixing the poly(hydroxyalkanoate) with other polymers. Thereby depending on the purpose and final end use the aqueous dispersion required properties can be adjusted in a wide range. Furthermore it also allows to substitute in standard formulations synthetic polymers by poly(hydroxyalkanoates) thus increasing thereby the amount of polymer present that are biodegradable and thereby using a naturally produced polymer. Thus the environmental impact of standard polymer dispersions containing synthetic homo or copolymers can be considerably reduced by completely or partly substituting the synthetic polymers by poly(hydroxyalkanoates).

Furthermore the dispersions obtained by the process of the present invention can be modified by reactive addition of monomers. This post-functionalization of poly(hydroxyalkanoate) polymers in dispersion form can be performed by addition of vinyl monomers in presence of radical initiators or redox systems. As post-functionalization can take place in water emulsion medium at a range of different temperatures, solids content reaction, duration and concentration of the radically initiator or redox systems. As suitable vinyl monomers a range of styrenic, acrylic, methacrylic or other vinyl double-bond containing compounds at different concentrations can be used.

The aqueous dispersions of poly(hydroxyalkanoates) according to the present invention can be used in a wide range of applications, for example for the preparation of all kind of coating compositions, particularly paper and board coating compositions or for the preparation of adhesive compositions, health and protection gloves, condoms, carpet backings or foams, or as construction additives or binder compounds or after spray-drying as re-dispersible powders.

The invention will now be described in more detail in view of the following examples.

Determination of particle size of dispersion using Dark-field microscope:

Equipment

Novex B-Series Dark-Field Microscope Linked to a Separate Fiber Optic Light Source EK-1

Procedure

Set Up and Measurement
For poly(hydroxyalkanoates) dispersions an objective of the type S40× N.A. is used to focus and take calibrant and sample images for analysis.
A drop of diluted dispersion is placed on top of a disposable glass slide and then covered by a cover glass.
A software “ImageFocus” is provided with a microscope and used for taking images of a sample via the microscope camera.

Analysis of the Microscope Images Using “ImageJ” Software
Before images of an actual sample are taken, the microscope and software have to be calibrated with known standards using well defined monomodal particle size distribution. The standards are polystyrene emulsions with different particle sizes which can be purchased from Sigma Aldrich (micro particle size standards of 200 nm and 500 nm particles). All images are processed with a specific software program called “ImageJ” (image processing and analysis in Java).
The method of analysis of the microscopy images taken is based on an initial analysis of images of a calibration sample. As the size of each particle on the images is exactly known, a value in nanometers can be given to each pixel on the image. Based on that calibration, when images of an unknown sample are taken the particle size and distribution can be easily determined.
A binary duplicate of one of the standards (500 nm) image is created first. This is done by first choosing a brightness threshold limit. When the right brightness balance is adjusted, the brightness value is noted and used for processing all subsequent images. The image is then converted to a binary duplicate.
As a standard monomodal product is used for the calibration, all particles in the image should of 500 nm in size. One can perform an actual calibration by determining how many nanometers in each pixel on the image via looking at the particles in the image.
The characteristic of interest is defined by diameter of the longest distance between any two points of the particles along the selection boundary in pixels. One can easily calibrate the microscope by assigning a nanometer value to each pixel bearing in mind that 22.536 pixels are 500 nm. Entering this into the software will set the scale and calibrate the program. To confirm the calibration the procedure is repeated with the 200 nm standard.

Determination of the Particle Size of an Unknown Sample

The steps described above are now applied to an actual sample image. As the scale is set by the performed calibration one can directly analyze the particles on the image by choosing the same brightness threshold as in the calibration making the image binary and directly perform the analysis. The results can then be analyzed statistically and particle size distribution can be presented graphically. The results for particle size are presented as number average value as the number of particles of each size is counted and presented vertically on the Gaussian distribution graph.

Determination of the Total Solids Content TSC:

The TSC was measured using a vacuum oven that is kept at constant temperature of 105+/−5° C. and at a pressure of approximately 1 Pa during sample analysis.

The following measurements are carried out in dublicate.
Recording the weight on an empty aluminum foil pan (M₁).
Adding approximately 0.9 to 1.1 g of dispersion to the pan and recording the mass (M₂).
Evenly spreading the dispersion through the pan.
Placing the aluminum pan in the pre-heated oven.
Evacuating the oven.
Maintaining the sample under vacuum for one hour.
Removing the pan, allowing to cool to room temperature and recording the dry mass (M3)

The TSC is calculated according to the following equation:

TSC(%)=[(M₃−M₁)/(M₂−M₁)]×100

If the duplicate measurements differ by more than 0.25%, the measurements are repeated.

### EXAMPLES

### Comparative Example

### Preparation of Polyhydroxybutyrate (PHB) Dispersion Using a Conventional Anionic Surfactant

To a reactor containing 40 g of PHB a powder that is being stirred using a high speed dispersant instrument at a shear rate of 8,150 s⁻¹ 93 g of water in which 2 g of potassium oleate have been dissolved and 0.12 g of an antifoam agent (Foamstopper 101) have been added. The mixture was allowed to stir until homogeneous and 0.1 g of a biocide agent (Acticide MBS 5050 10%) was added. The mixture was further stirred for 10 min obtaining a homogeneous dispersion with a total solids content of 30% and a pH of 7.7. The dispersion was stable only for a few minutes followed by a complete sedimentation of the solid matter leaving a clear level on top of the reactor.

### Comparative Example 2

### Preparation of Polyhydroxybutyrate (PHB) Dispersion Using Conventional Nonionic Surfactant

To a reactor containing 100 g of PHB powder that is being stirred using a high speed dispersant instrument at a shear rate of 8,150 s⁻¹ 233 g of water in which 5 g of Tween 81 (polyoxyethylenesorbitanmonooleate), available from Sigma Aldrich, have been mixed and 0.23 g of antifoam agent (Foamstopper 101) have been added. The mixture was allowed to stir until homogeneous and then 0.1 g of a biocide agent (Acticide MBS 5050 10%) was added. The mixture was further stirred for 10 min obtaining a homogeneous dispersion with a total solids content of 30 wt.-% and a pH of 7.6. The emulsion was stable for approximately 30 min followed by the appearance of a clear level on top of the reactor.

### Example 1

### Preparation of 40% Solids Content Dispersion of PHB Powder Using High Viscosity Poly(vinylalcohol) (PVOH) Stabilizer

To a reactor containing 40 g of PHB powder that is being stirred using a high speed dispersant instrument at a shear rate of 8,150 s⁻¹ 30 g of a 5% solution of Mowiol 56-98, a 4 wt.-% aqueous solution thereof at 20° C. exhibits a viscosity measured according to DIN 53015 using a No. 2 Ball of 56 mPa·s (available from Kuraray) was added, followed by 22 g of water and 0.12 g of an antifoam agent (Foamstopper 101). The mixture was allowed to stir until homogeneous and then 0.1 g of a biocide agent (Acticide MBS 5050 10%) was added. The mixture was further stirred for 10 min obtaining a homogeneous dispersion with a total solids content of 41% and a pH of 7.7. The dispersion was left at room temperature to test long term stability. The product was inspected visually at certain time intervals for sedimentation and creaming. Small samples for measuring of total solids content (TSC) were also taken regularly from top and bottom part of the sample and the numbers compared for any sign of sedimentation or creaming. The results are summarized in Table 1.

### Example 2

### Preparation of a 40% Solids Content Dispersion of PHB Powder Using Low Viscosity PVOH Stabilizer

To a vessel containing 40 g of PHB powder that is being stirred using a high speed dispersant instrument at a shear rate of 8,150 s⁻¹ 30 g of a 5% solution of Mowiol 10-98, a 4 wt.-% aqueous solution thereof at 20° C. has a viscosity measured according to DIN 53015 Ball No. 2 of 10 mPa·s, available from Kuraray, in water was added, followed by 22 g of water and 0.12 g of an antifoam agent (Foamstopper 101). The mixture was allowed to stir until homogeneous and then 0.1 g of a biocide agent (Acticide MBS 5050 10%) was added. The mixture was further stirred for 10 min obtaining a homogeneous dispersion with a total solids content of 40% and a pH of 7.7. The dispersion was left at room temperature to test long term stability. The product was inspected visually at certain time intervals for sedimentation and creaming. Small samples for measurement of TSC were also taken regularly from the top and bottom of the sample and the numbers compared for any sign of sedimentation or creaming. The results are shown in Table 1. The dispersion prepared was stable for 35 days before it started showing signs of sedimentation and creaming.

### Example 3

### Preparation of a 40% Solids Content Blend of a PHB Dispersion and Carboxylated Styrene-Butadiene Copolymer Emulsion Using High Viscosity PVOH Stabilizer

To a vessel containing 32 g of PHB powder that is being stirred using a high speed dispersant instrument at a shear rate of 8,150 s⁻¹ 40 g of a 5% solution of Mowiol 56-98 (as in Example 1) in water was added, followed by 40 g of water and 0.12 g of an antifoam agent (Foamstopper 101). The mixture was allowed to stir until homogeneous and then 0.1 g of a biocide agent (Acticide MBS 5050 10%) was added. The mixture was further stirred for 10 min and then 60 g (20 wt.-% based on the amount of PHB) of carboxylated styrene-butadiene copolymer emulsion was added. The blended dispersion was stirred for 5 min obtaining a product with a TSC of 40% and a pH of 7.9. The dispersion was left at room temperature to test long term stability. The product was subjected to periodic visual inspection to determine whether sedimentation and creaming were occurring. Small samples for measurement of TSC were also taken regularly from the top and bottom part of the sample and the numbers compared for any sign of sedimentation or creaming. The dispersion prepared was stable for 65 days before it started showing signs of sedimentation and creaming.

A quantitative analysis of the stability of the PHA dispersions was performed by measuring the total solid content of the top layer (approx. 1 cm below the top) and bottom layer (approx. 1 cm above the bottom) of the respective dispersion placed in 100 ml containers. The particle size of the product at the beginning, 40 days in and at the end of the analysis has been determined as well. The results are shown in Table 1 and 2.

TABLE 1
TSC determination of the dispersion from Examples 1-3 at specific
time periods

| | | | Example 1 | Example 2 | Example 3 |
|---|---|---|---|---|---|
| Time period | | | TSC (%) | TSC (%) | TSC (%) |
| 1 | week | Top layer | 40.82 | 39.83 | 39.73 |
| | | Bottom layer | 40.76 | 40.10 | 39.52 |
| 2 | week | Top layer | 40.76 | 39.73 | 39.30 |
| | | Bottom layer | 40.62 | 39.62 | 39.56 |
| 1 | months | Top layer | 40.70 | 39.34 | 39.73 |
| (35 days) | | Bottom layer | 40.43 | 39.72 | 39.61 |
| 2 | months | Top layer | 40.53 | — | 39.80 |

| | | | | |
|---|---|---|---|---|
| (65 days) | Bottom layer | 41.10 | — | 40.17 |

As seen in Table 1 Examples 1 and 3 did not show any change in total solid content over a 65 days period. Over this period, no noticeable visual changes in terms of creaming or sedimentation were noticed. After that period signs of creaming were noticed visually and the measurements were terminated.

The sample from example 2 was stable for 35 days (as shown by the TSC results). After that period again visual changes (creaming) were observed and the measurements were terminated.

The deviations of the TSC values throughout the analysis were under 0.5% which is within the statistical error of the measurement.

TABLE 2
Particle size for Examples 1-3, determined via dark field microscopy

| | Example 1 | Example 2 | Example 3 |
|---|---|---|---|
| | Particle size | Particle size | Particle size |
| Time period | (nm) | (nm) | (nm) |
| Initial | 699 | 800 | 729 |
| 40 days | 703 | 1200 | 725 |
| 65 days | 786 | — | 801 |
| 68 days | 978 | — | 1205 |

The results from Table 2 show some evidence of agglomeration after 65 days in the case of Examples 1 and 3 even though the dispersion was still stable in comparison to the original and with very similar TSC results for top and bottom of the sample. In the case of Example 2 the particle size was measured after the dispersion had lost stability and a 50% increase in particle size was found.

1. A method for producing an aqueous dispersion of poly(hydroxyalkanoates) comprising dispersing a powder containing one or more poly(hydroxylalkanoates) in an aqueous medium in presence of a colloidal stabilizer using a high shear disperser at a shear rate of 10 s⁻¹-750,000 s⁻¹.

2. The method of claim 1, wherein the shear rate is in the range of 1000 s⁻¹-250,000 s⁻¹.

3. The method of claim 1, wherein the aqueous medium comprises a liquid carrier comprising at least 80 wt. % water based on a total weight of the liquid carrier.

4. The method of claim 1, wherein the poly(hydroxyalkanoate) comprises structural units derived from one or more selected from the group consisting of 3-hydroxybutyrate, 4-hydroxybutyrate, 3-hydroxyvalerate, 3-hydroxyhexanoate, 3-hydroxyhexanoate, 3-hydroxynonanoate, 3-hydroxypropionate and mixtures thereof.

5. The method of claim 1, wherein the poly(hydroxyalkanoate) is selected from the group consisting of poly(3-hydroxybutyrate), poly(4-hydroxybutyrate), poly(3-hydroxybutyrate-co-4-hydroxybutyrate), poly(3-hydroxybutyrate-co-3-hydroxyvalerate), poly(3-hydroxybutyrate-co-3-hydroxyhaxanoate) and mixtures thereof.

6. The method of claim 1, wherein the poly(hydroxyalkanoate) is present in an amount of 5-90 wt based on a total weight of the aqueous dispersion.

7. The method of claim 1, wherein the colloidal stabilizer is present in an amount of 0.5-7 wt based on a total weight of the aqueous dispersion.

8. The method of claim 1, wherein the colloidal stabilizer is selected from the group consisting of poly(vinylalcohol), starch and starch derivatives, cellulose and cellulose derivatives and mixtures thereof.

9. The method of claim 1, wherein the colloidal stabilizer comprises a poly(vinylalcohol) a 4 wt.-% aqueous solution thereof having a viscosity measured at 20° C. according to DIN 53015 using the Ball No. 2 of 15-140 mPas.

10. The method of claim 1, wherein a number average particle size of the poly(hydroxyalkanoates) in the dispersion measured using a Dark-field microscope is in the range of 30-5,000 nm.

11. The method of claim 1, further comprising adding compounding additives selected from the group consisting of antifoam agents, biocides and mixtures thereof.

12. The method of claim 1, further comprising mixing the aqueous dispersion of poly(hydroxyalkanoates) with at least one further aqueous polymer composition comprising a polymer different from poly(hydroxyalkanoates).

13. The method of claim 12, wherein the polymer different from poly(hydroxyalkanoates) is selected from the group consisting of styrene homo and copolymers, butadiene homo and copolymers, acrylic or methacrylic homo and copolymers, vinylacetate homo or copolymers, acrylonitrile homo and copolymers, poly(vinylacetate-co-ethylene), polyurethanes, polyesters and mixtures thereof.

14. The method of claim 1, wherein a total solids content of the dispersion is 5-90 wt. % based on a total weight of the aqueous dispersion.

15. An aqueous dispersion of poly(hydroxyalkanoates) obtainable by the method of claim 9.

16. The method of claim 12, wherein the amount of the at least one further aqueous polymer composition comprising a polymer different from poly(hydroxyalkanoates) ranges from 5-90 wt.-% based on a total amount of the aqueous dispersion of poly(hydroxyalkanoates) and the at least one further aqueous polymer composition comprising a polymer different from poly(hydroxyalkanoates).
